(19) United States
(12) Patent Application Publication
(10) Pub. No.: US 2009/0093589 A1
(43) Pub. Date: Apr. 9, 2009

(54) USE OF HYPERBRANCHED POLYCARBONATES AS A DISPERSING AGENT FOR PIGMENTS

(75) Inventors: Bernd Bruchmann, Freinsheim (DE); Andres Carlos Garcia Espino, Mannheim (DE); Matthias Kluglein, Ludwigshafen (DE); Wolfgang Best, Freinsheim (DE); Joachim Jesse, Weisenheim (DE); Benno Sens, Neustadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/299,323

(22) PCT Filed: May 15, 2007
(86) PCT No.: PCT/EP07/54721

§ 371 Date: Nov. 3, 2008

(30) Foreign Application Priority Data
May 23, 2006 (EP) 06114393.9

(51) Int. Cl. C08L 69/00; C08G 64/02

(52) U.S. Cl. 524/612; 528/370

(57) ABSTRACT

Use of high functionality hyperbranched polycarbonates obtainable by

a) preparing one or more different condensation products (K) either by

a1) reacting at least one organic carbonate (A) of the general formula RO[(CO)O]ₙR with at least one aliphatic, aliphatic/aromatic or aromatic alcohol (B) having at least 3 OH groups by elimination of alcohols ROH, where each R is independently a straight chain or branched aliphatic, aromatic-aliphatic or aromatic hydrocarbyl radical having 1 to 20 carbon atoms and the R radicals may also be bonded to each other to form a ring comprising the grouping —O[(CO)O]ₙ—, where n is an integer from 1 to 5,

or

a2) reacting phosgene, diphosgene or triphosgene with the aliphatic, aliphatic/aromatic or aromatic alcohol (B) to liberate hydrogen chloride,

the quantitative ratio of the alcohols (B) to the carbonates (A) or to the phosgenes in the reaction mixture being so chosen that the condensation products (K) comprise on average either one carbonate or carbamoyl chloride group and more than one OH group or one OH group and more than one carbonate or carbamoyl chloride group,

and

b) intermolecularly reacting the condensation products (K) from step a),

as a dispersant for a pigment.

The present invention relates to the use of high functionality hyperbranched polycarbonates obtainable by
a) preparing one or more condensation products (K) either by
a1) reacting at least one organic carbonate (A) of the general formula RO[(CO)O]ₙR with at least one aliphatic, aliphatic/aromatic or aromatic alcohol (B) having at least 3 OH groups by elimination of alcohols ROH, where each R is independently a straight chain or branched aliphatic, aromatic-aliphatic or aromatic hydrocarbyl radical having 1 to 20 carbon atoms and the R radicals may also be bonded to each other to form a ring comprising the grouping —O[(CO)O]ₙ—, where n is an integer from 1 to 5,
   or
a2) reacting phosgene, diphosgene or triphosgene with the aliphatic, aliphatic/aromatic or aromatic alcohol (B) to liberate hydrogen chloride,
   the quantitative ratio of the alcohols (B) to the carbonates (A) or to the phosgenes in the reaction mixture being so chosen that the condensation products (K) comprise on average either one carbonate or carbamoyl chloride group and more than one OH group or one OH group and more than one carbonate or carbamoyl chloride group,
   and
b) intermolecularly reacting the condensation products (K),
as a dispersant for a pigment.

The present invention also relates to pigment preparations comprising, as essential constituents, (I) at least one pigment and (II) at least one of these polycarbonates as a dispersant, and also to the production of these pigment preparations and to their use for coloration of liquid application media and plastics.

Dispersion of a pigment in liquid application media requires mechanical forces whose magnitude depends on the wettability of the pigment and its affinity for the application medium. To facilitate dispersion, it is customary to use dispersants which shall not only prevent reagglomeration of the pigment particles and also flocculate formation but also provide additional stabilization to the pigment dispersion obtained. The technical requirements of dispersants are very demanding, in particular they generally also include broadband compatibility not only with waterborne but also with solventborne systems as well as economical availability.

Proposed dispersants now even include polymers having a hyperbranched or else dendrimeric structure. Polymers hitherto described for this purpose are based on polyamides or polyester amines (EP-A-882 772 and 1 295 919), polyethers (WO-A-03/62306), polyurethanes (WO-A-02/81071 and 03/91347) and especially polyesters (EP-A-882 772 and 1 295 919 and WO-A-00/37542, 02/57004 and 04/37928).

Dendrimeric polyamides or polyesters are very costly and inconvenient to produce in multiple step syntheses, which distinctly limits their possibilities of industrial use. The multistep synthesis to form polyether systems via ring opening polymerization with subsequent chain extension or modification with ethylene oxide or propylene oxide is likewise very costly and inconvenient both in engineering and safety terms.

Hyperbranched polymers based on amides, esters, ester amides or polyurethanes, although producible in one step operations, generally have high inherent viscosities and therefore are useful for a limited number of solvents only, which appreciably reduces their possible uses.

It is an object of the present invention to provide dispersants having the required performance profile and, in particular, a low inherent viscosity and also good compatibility with a wide variety of pigments and solvents and also obtainable in an economical manner.

We have found that this object is achieved by using the high functionality hyper-branched polycarbonates defined at the beginning as dispersants for pigments.

The high functionality hyperbranched polycarbonates which are to be used according to the present invention and their synthesis are known from WO-A-2005/23234. PCT/EP2006/060240, as yet unpublished, describes their use as flow auxiliaries.

Hyperbranched polycarbonates are uncrosslinked macromolecules having hydroxyl and carbonate or carbamoyl chloride groups that are both structurally and molecularly nonunitary. They may be constructed, proceeding from the central molecule, analogously to dendrimers, but with nonunitary chain length for the branches. However, they may also be constructed linearly with functional, branched side groups. Finally, they may also comprise, as a combination of the two extremes, linear and branched moieties.

“Hyperbranched” shall mean for the purposes of the present invention that the degree of branching (DB; see also Acta Polymerica 48, pp. 30 ff (1997)), i.e., the average number of dendritic linkages plus the average number of end groups per molecule, divided by the average number of dendritic linkages plus the average number of linear linkages plus the average number of end groups per molecule, is in the range from 0.1 to 0.99, preferably in the range from 0.2 to 0.99 and more preferably in the range from 0.2 to 0.95.

“Dendrimeric” shall for the purposes of the present invention refer to a degree of branching DB in the range from 0.99 to 1.0.

Useful starting materials for the condensation products (K) underlying the polycarbonates to be used according to the present invention may include phosgene, diphosgene or triphosgene, preferably phosgene (process variant a2)), but it is particularly preferable to use organic carbonates (A) of the general formula RO[(CO)O]ₙR (process variant a1)).

The R radicals are each independently a straight chain or branched aliphatic, cycloaliphatic, aromatic-aliphatic (araliphatic) or aromatic hydrocarbyl radical having 1 to 20 carbon atoms, preferably 1 to 12 carbon atoms, in particular 1 to 6 carbon atoms. The two R radicals may also be bonded to each other to form a ring comprising the grouping —O[(CO)O]ₙ—, in which case the R radicals are each for example ethylene or 1,2- or 1,3-propylene. The two R radicals may be the same or different, preferably they are the same. Their meaning is preferably that of an aliphatic hydrocarbyl radical, more preferably that of a straight chain or branched alkyl radical and most preferably a straight chain alkyl radical having 1 to 4 carbon atoms, or that of a substituted or unsubstituted phenyl radical.

Examples of suitable R radicals are methyl, ethyl, n-propyl, isopropyl, n-butyl, isobutyl, sec-butyl, tert-butyl, n-hexyl, n-heptyl, n-octyl, 2-ethylhexyl, n-decyl, n-dodecyl, n-tetradecyl, n-hexadecyl, n-octadecyl, n-eicosyl, cyclopentyl, cyclohexyl, cyclooctyl, cyclododecyl, phenyl, o- and p-tolyl and naphthyl. Methyl, ethyl, n-butyl and phenyl are preferred.

n is an integer from 1 to 5, preferably from 1 to 3 and more preferably from 1 to 2.

The carbonates are most preferably monocarbonates of the general formula RO(CO)OR (n=1).

Examples of useful aliphatic, aromatic/aliphatic and aromatic monocarbonates are dimethyl carbonate, diethyl carbonate, di-n-propyl carbonate, di-n-butyl carbonate, diisobutyl carbonate, dipentyl carbonate, dihexyl carbonate, dicyclohexyl carbonate, diheptyl carbonate, dioctyl carbonate, didecyl carbonate, didodecyl carbonate, ethylene carbonate, 1,2- and 1,3-propylene carbonate, diphenyl carbonate, ditolyl carbonate, dixylyl carbonate, dinaphthyl carbonate, ethylphenyl carbonate and dibenzyl carbonate.

Examples of carbonates where n is greater than 1 are dialkyl dicarbonates, such as di(tert-butyl) dicarbonate, and dialkyl tricarbonates, such as di(tert-butyl) tricarbonate.

Preference is given to aliphatic carbonates, in particular dimethyl carbonate, diethyl carbonate, di-n-propyl carbonate, di-n-butyl carbonate and diisobutyl carbonate. Diphenyl carbonate is a preferred aromatic carbonate.

The organic carbonates are reacted with an aliphatic, cycloaliphatic, aliphatic/aromatic or aromatic alcohol (B) comprising at least 3 OH groups or with mixtures of two or more different alcohols (B).

The alcohol (B) may be branched or unbranched, substituted or unsubstituted and preferably has 3 to 26 carbon atoms. It is preferably a cycloaliphatic and more preferably an aliphatic alcohol.

Examples of useful alcohols (B) are: glycerol, trimethylolmethane, trimethylolethane, trimethylolpropane, trimethylolbutane, 1,2,4-butanetriol, tris(hydroxymethyl)amine, tris(hydroxyethyl)amine, tris(hydroxypropyl)amine, pentaerythritol, diglycerol, triglycerol, polyglycerols, bis(trimethylolpropane), tris(hydroxymethyl) isocyanurate, tris(hydroxyethyl) isocyanurate, phloroglucine, pyrogallol, hydroxyhydroquinone, trihydroxytoluene, trihydroxydimethylbenzene, hexahydroxybenzene, 1,3,5-benzenetrimethanol, 1,1,1-tris(4′-hydroxyphenyl)methane, 1,1,1-tris(4′-hydroxyphenyl)ethane, sugars, such as glucose, sugar derivatives, such as sorbitol, mannitol, threitol, erythritol, adonitol (ribitol), arabitol (lyxitol), xylitol, dulcitol (galactitol), maltitol and isomalt, and polyesterols.

A further particularly interesting group of useful alcohols (B) is that of their alkoxylation products. The polyetherols of tri- or higher functionality are based in particular on the reaction products with ethylene oxide, propylene oxide or butylene oxide or mixtures thereof, of which ethylene oxide and/or propylene oxide are preferred. The amount of alkylene oxide used per mole of alcohol OH group is generally in the range from 1 to 30, preferably in the range from 1 to 20, more preferably in the range from 1 to 10 and most preferably in the range from 1 to 5 mol.

Examples of particularly preferred alcohols (B) are glycerol, trimethylolethane, trimethylolpropane, 1,2,4-butanetriol, pentaerythritol and reaction products thereof with ethylene oxide and/or propylene oxide, of which the reaction products with ethylene oxide and/or propylene oxide are very particularly preferred.

The at least trifunctional alcohols (B) can also be used in admixture with difunctional alcohols (B′) and their mixing ratio shall be chosen such that its average OH functionality is greater than 2.

Examples of useful alcohols (B′) are: ethylene glycol, diethylene glycol, triethylene glycol, 1,2-propanediol, 1,3-propanediol, dipropylene glycol, tripropylene glycol, neopentylglycol, 1,2-butanediol, 1,3-butanediol, 1,4-butanediol, 1,2-, 1,3-, 1,5-pentanediol, 1,6-hexanediol, 1,2-cyclopentanediol, 1,3-cyclopentanediol, 1,2-cyclohexanediol, 1,3-cyclohexanediol, 1,4-cyclohexanediol, 1,1-cyclohexanedimethanol, 1,2-cyclohexanedimethanol, 1,3-cyclohexanedimethanol, 1,4-cyclohexanedimethanol, bis(4-hydroxycyclohexyl)methane, bis(4-hydroxycyclohexyl)ethane, 2,2-bis(4-hydroxycyclohexyl)propane, 1,1′-bis(4-hydroxyphenyl)-3,3-5-trimethylcyclohexane, resorcinol, hydroquinone, 4,4′-dihydroxybiphenyl, bis(4-hydroxyphenyl) sulfide, bis(4-hydroxyphenyl) sulfone, bis(hydroxymethyl)benzene, bis(hydroxymethyl)toluene, bis(p-hydroxyphenyl)methane, bis(p-hydroxyphenyl)ethane, 2,2-bis(p-hydroxyphenyl)-propane, 1,1-bis(p-hydroxyphenyl)cyclohexane, dihydroxybenzophenone, difunctional polyetherpolyols based on alkoxylation products of difunctional alcohols, polytetrahydrofurans having an average molecular weight in the range from 162 to 2000, polycaprolactones and polyesterols based on diols and dicarboxylic acids.

The difunctional alcohols (B′) can be used to fine tune the properties of the polycarbonate. When difunctional alcohols (B′) are used, their amount is generally in the range from 0.1 to 39.9 mol %, preferably in the range from 0.1 to 35 mol %, more preferably in the range from 0.1 to 25 mol % and most preferably in the range from 0.1 to 10 mol %, all based on the total amount of alcohols (B) and (B′).

The properties of the polycarbonate can also be fine tuned using difunctional carbonyl-reactive compounds (A′). These are compounds having two carbonate and/or carboxyl groups.

The carboxyl groups may be present in free or derivatized form, i.e., as well as the carboxylic acids themselves or their salts with uni- or bivalent cations it is also possible to use the carbonyl chlorides, carboxylic anhydrides, or carboxylic esters, of which the carboxylic esters and carboxylic anhydrides are preferred and the carboxylic esters, in particular the C₁-C₄ alkyl esters, especially the methyl, ethyl and butyl esters, are particularly preferred.

Examples of useful compounds (A′) are dicarbonates or dicarbamoyl chlorides of diols, such as ethylene glycol, 1,2-propanediol, 1,3-propanediol, 1,1-dimethylethane-1,2-diol, 2-butyl-2-ethyl-1,3-propanediol, 2-ethylpropane-1,3-diol, 2-methylpropane-1,3-diol, neopentylglycol, neopentyl glycol hydroxypivalate, 1,2-butanediol, 1,3-butanediol, 1,4-butanediol, 1,6-hexanediol, 1,10-decanediol, bis(4-hydroxycyclohexane)isopropylidene, tetramethylcyclobutanediol, 1,2-cyclohexanediol, 1,3-cyclohexanediol, 1,4-cyclohexanediol, cyclooctanediol, norbornanediol, pinanediol, decalindiol, 2-ethylhexane-1,3-diol, 2,4-diethyloctane-1,3-diol, hydroquinone, bisphenol A, bisphenol F, bisphenol B, bisphenol S, 2,2-bis(4-hydroxycyclohexyl)propane, 1,1-cyclohexanedimethanol, 1,2-cyclohexanedimethanol, 1,3-cyclohexanedimethanol, 1,4-cyclohexanedimethanol, 1,2-cyclohexanediol, 1,3-cyclohexanediol and 1,4-cyclohexanediol.

The dicarbonates or dicarbamoyl chlorides (A′) can be prepared for example by reacting the diols with an excess of the above-recited carbonates (A) or of chlorocarbonic esters in such a way that the dicarbonates obtained are both-sidedly substituted with RO(CO)-groups. A further possibility is to react the diols with phosgene to form the corresponding chlorocarbonic esters and then to react these chlorocarbonic esters with alcohols.

Examples of useful dicarboxylic acids and dicarboxylic anhydrides are: oxalic acid, maleic acid, fumaric acid, succinic acid, glutaric acid, adipic acid, sebacic acid, dodecanedioic acid, phthalic acid, isophthalic acid, terephthalic acid, azelaic acid, tetrahydrophthalic acid, 1,4-cyclohexanedicarboxylic acid, suberic acid, phthalic anhydride, tetrahydrophthalic anhydride, hexahydrophthalic anhydride, tetrachlorophthalic anhydride, endomethylenetetrahydrophthalic anhydride, glutaric anhydride and dimeric fatty acids and their isomers and hydrogenation products.

When difunctional compounds (A′) are used, their amount is generally in the range from 0.1 to 40 mol %, preferably in the range from 0.1 to 35 mol %, more preferably in the range from 0.1 to 25 mol % and most preferably in the range from 0.1 to 10 mol %, all based on the total amounts of carbonates (A) or phosgenes and compounds (A′).

Preparing the condensation products (K) in step a) is effected in the case of the reaction of the organic carbonate (A) with the alcohol (B) or the alcohol mixture ((B)+(B′)) by eliminating a monofunctional alcohol from the carbonate molecule (variant a1)) and in the case of the corresponding reaction of phosgene, diphosgene or triphosgene by eliminating hydrogen chloride (variant a2)).

It is necessary here for the quantitative ratio of alcohols (B) (and if appropriate (B′)) to the carbonates (A) or to the phosgenes to be set such that the condensation products (K) comprise on average either one carbonate or carbamoyl chloride group and more than one OH group, preferably at least two OH groups, or one OH group and more than one carbonate or carbamoyl chloride group, preferably at least two carbonate or carbamoyl chloride groups.

The reaction temperature should be sufficient to react the alcohol component with the appropriate carbonyl component. When carbonate (A) is used, the temperature is generally in the range from 60 to 180° C., preferably in the range from 80 to 160° C., more preferably in the range from 100 to 160° C. and most preferably in the range from 120 to 140° C. When the reaction is carried out with a phosgene, the temperature is generally in the range from −20° C. to 120° C., preferably in the range from 0 to 100° C. and more preferably in the range from 20 to 80° C.

The condensation can be carried out in the presence of a solvent. Useful solvents include organic solvents, for example aromatic and (cyclo)aliphatic hydrocarbons, halogenated hydrocarbons, ketones, esters, amides, ethers and cyclic carbonates, such as decane, dodecane, benzene, toluene, xylene, solvent naphtha, chlorobenzene, dimethylformamide and dimethylacetamide.

Preferably, however, no solvent is added.

The order in which the individual components are added usually plays only a minor part. It is generally sensible to add the deficient component to an initial charge of the excess component. However, it is also possible to mix the two components together before the start of the reaction and then to heat the mixture to the requisite reaction temperature.

A plurality of different condensation products (K) can be produced in step a). This can be achieved by using different alcohols and/or different carbonates or phosgenes. Mixtures of different condensation products are also obtainable through the choice of the ratio of the alcohols used and the carbonates or phosgenes.

The condensation products (K) have hydroxyl groups and carbonate or carbamoyl chloride groups as end groups, and undergo an intermolecular reaction (polycondensation) in step b) to form the high functionality hyperbranched polycarbonates of the present invention.

“High functionality” is herein to be understood as meaning that the polycarbonates, as well as the carbonate or carbamoyl groups forming the polymeric scaffold, have at least three, preferably at least six, more preferably at least ten functional groups as end or side groups. The functional groups comprise carbonate or carbamoyl chloride groups and/or OH groups. There is in principle no upper limit to the number of terminal or lateral functional groups, but polymers having a very high number of functional groups may have undesirable properties, for example high viscosity or poor solubility. The high functionality polycarbonates to be used according to the present invention therefore have in general not more than 500 and preferably not more than 100 terminal or lateral functional groups.

The intermolecular condensation of step b) generally follows directly on from the condensation reaction of step a). If desired, the reaction temperature can be slightly raised to about 60 to 250° C., preferably 80 to 230° C. and more preferably 100 to 200° C.

To speed the polycondensation in particular, the monofunctional alcohol ROH being liberated can be removed from the reaction equilibrium. This can be accomplished, in particular in the case of alcohols having a boiling point ≦140° C., by distillation, if appropriate under reduced pressure, or else by stripping with a gas stream that is essentially inert under the reaction conditions, examples being nitrogen, water vapor, carbon dioxide, or with an oxygen-containing gas, such as air or lean air.

Catalysts or catalyst mixtures may further also be added to speed the reaction. These catalysts or catalyst mixtures may be included directly in the initial charge of the starting materials in step a), or be added later.

Useful catalysts include in particular compounds that catalyze esterification or transesterification reactions, examples being inorganic and organic bases, such as alkali metal hydroxides, carbonates and bicarbonates, preferably the sodium, potassium and cesium compounds, tertiary amines and guanidines, ammonium compounds, phosphonium compounds, organometallic compounds, such as organoaluminum, organotin, organozinc, organotitanium, organozirconium and organobismuth compounds, and double metal cyanides (DMCs) and also mixtures thereof.

Preferred catalysts are potassium hydroxide, potassium carbonate, potassium bicarbonate, diazabicyclooctane (DABCO), diazabicyclononene (DBN), diazabicycloundecene (DBU), imidazoles, such as imidazole, 1-methylimidazole and 1,2-dimethylimidazole, titanium tetrabutoxide, titanium tetraisopropoxide, dibutyltin oxide, dibutyltin dilaurate, tin dioctoate and zirconium acetylacetonate.

Useful amounts of catalyst range generally from 50 to 10 000 ppm and preferably from 100 to 5000 ppm, based on the amount of alcohol or alcohol mixture used.

The intermolecular polycondensation can be controlled not only by adding a suitable catalyst but also by choosing a suitable reaction temperature. The average molecular weight of the polycarbonates can further be controlled via the composition of the starting materials and via the reaction time.

When the polycondensation is carried out at elevated temperature, the polycarbonates obtained are typically stable at room temperature for a prolonged period, for example for at least 6 weeks, without cloudiness, precipitation and/or increased viscosity.

The reaction can be carried out at atmospheric pressure or under reduced or superatmospheric pressure in reactors or reactor batteries operated batchwise, semicontinuously or continuously.

There are various ways to stop the intermolecular polycondensation reaction.

For example, the temperature can be lowered to a value at which the reaction ceases and the polycondensation product is stable in storage. This is generally the case at temperatures ≦60° C., preferably ≦50° C., more preferably ≦40° C. and most preferably at room temperature.

It is further possible to deactivate the catalyst. In the case of basic catalysts, this can be done simply by adding an acidic component, for example a Lewis acid or an organic or inorganic protic acid, such as phosphoric acid.

The reaction can also be stopped by diluting with a pre-cooled solvent. This is especially preferable when the viscosity of the reaction mixture has to be adjusted by addition of solvent.

Finally, the polycondensation can also be stopped by adding a component having functional groups that are reactive with the focal group of the condensation products (K). A mono-, di- or polyamine can be added for example in the case of a carbonate or carbamoyl focal group. In the case of an OH focal group, a mono-, di- or polyisocyanate, an epoxy-containing compound or an acid derivative that is reactive with OH groups can be added.

Provided suitable reaction conditions are chosen, the as-synthesized polycarbonates can generally be used for the desired application without further purification.

If necessary, however, the reaction mixture obtained can be subjected to a decolorization, for example by treatment with activated carbon or metal oxides, such as alumina, silica, magnesia, zirconia, boron oxide or mixtures thereof, in amounts of for example 0.1 to 50% by weight, preferably 0.5 to 25% by weight, more preferably 1% to 10% by weight, at temperatures of for example 10 to 100° C., preferably 20 to 80° C. and more preferably 30 to 60° C.

If appropriate, the reaction mixture can also be filtered to remove any precipitates present.

If desired, the polycondensation product can also be freed of low molecular weight, volatile compounds by stripping. To this end, after the desired degree of polycondensation has been reached, the catalyst can be optionally deactivated and the low molecular weight volatiles, for example monoalcohols, phenols, carbonates, hydrogen chloride or volatile oligomeric or cyclic compounds can be removed distillatively, if appropriate by introducing a gas, preferably nitrogen, carbon dioxide or air, if appropriate under reduced pressure.

The polycarbonates to be used according to the present invention are branched, but uncrosslinked.

“Uncrosslinked” shall herein be understood as meaning that the degree of crosslinking is ≦15% by weight, preferably ≦10% by weight, determined via the insoluble fraction of the polymer.

The insoluble fraction of the polymer was determined by four hour extraction with the gel permeation chromatography solvent (tetrahydrofuran, dimethylacetamide or hexafluoroisopropanol) in a Soxhlet and weighing the residue after it has been dried to constant weight.

The polycarbonates to be used according to the present invention ideally have on average either one carbonate or carbamoyl chloride group as focal group and more than two OH groups or else one OH group as focal group and more than two carbonate or carbamoyl chloride groups. The number of reactive groups follows from the constitution of the condensation products (K) and the degree of polycondensation.

The polycarbonates to be used according to the present invention, as well as the hydroxyl, carbonate and carbamoyl chloride groups already present, may comprise further functional groups when components were involved in the polycondensation reaction which, as well as hydroxyl, carbonate or carbamoyl groups, contain further functional groups or functional elements.

Additional functional groups or functional elements may be for example carbamate groups, primary, secondary or tertiary amino groups, ether groups, carboxylic acid groups or derivatives thereof, sulfonic acid groups or derivatives thereof, phosphonic acid groups or derivatives thereof, silane groups, siloxane groups, aryl radicals or long chain alkyl radicals.

Examples of components whose incorporation brings about a functionalization with these groups are listed hereinbelow:
carbamate groups: for example ethanolamine, propanolamine, isopropanolamine, 2-(butylamino)ethanol, 2-(cyclohexylamino)ethanol, 2-amino-1-butanol, 2-(2′-aminoethoxy)ethanol, higher alkoxylation products of ammonia, 4-hydroxy-piperidine, 1-hydroxyethylpiperazine, diethanolamine, dipropanolamine, diisopropanolamine, tris(hydroxymethyl)aminomethane, tris(hydroxyethyl)aminomethane, ethylenediamine, propylenediamine, hexamethylenediamine and isophoronediamine, alkyl and aryl isocyanates, alkyl and aryl diisocyanates;
mercapto groups: for example mercaptoethanol;
tertiary amino groups: for example triethanolamine, tripropanolamine, N-methyldiethanolamine, N-methyldipropanolamine or N,N-dimethylethanolamine;
ether groups: for example polyetherols of di- or higher functionality;
ester groups: for example dicarboxylic acids, tricarboxylic acids, dicarboxylic esters, such as dimethyl terephthalate, and tricarboxylic esters;
long chain alkyl radicals: for example long chain alkanols and alkanediols, alkyl isocyanates and alkyl diisocyanates;
urethane and urea groups: for example primary and secondary amines.

The hydroxyl, carbonate and carbamoyl groups present in the polycarbonates can also have been transfunctionalized by subsequent groups already present.

For instance, hydroxyl groups can be converted into the following groups: ester or urethane groups, obtainable by addition of molecules comprising acid groups or isocyanate groups. Acid groups can be formed by reaction with anhydride groups. Finally, the polycarbonates can be converted with alkylene oxides, in particular ethylene oxide, propylene oxide or butylene oxide, into high functionality polycarbonate-polyetherpolyols.

The average molecular weight M_{w} of the polycarbonates to be used according to the present invention is generally in the range from 500 to 500 000, preferably in the range from 1000 to 150 000, more preferably in the range from 1000 to 50 000 and most preferably in the range from 1500 to 25 000.

The polydispersity M_{w}/Mₙ of the polycarbonates to be used according to the present invention is generally in the range from 1.1 to 50, preferably in the range from 1.2 to 40 and more preferably in the range from 1.2 to 35.

The polycarbonates to be used according to the present invention are excellent dispersants for pigments. They facilitate the dispersion of pigments in their application media and lead to an overall enhancement of their performance properties, in particular their color properties, examples being color strength and transparency, and of their rheological properties, examples being lower viscosity and flocculation resistance in liquid application media.

The polycarbonates to be used according to the present invention can be incorporated in the respective application medium separately from the pigments, preferably beforehand or concurrently. It is more preferable, however, to process them in advance with the pigments to form liquid or preferably solid pigment preparations.

The present invention accordingly also provides pigment preparations comprising
(I) at least one pigment
   and
(II) at least one polycarbonate according to the present invention as a dispersant.

Preferably, the pigment preparations of the present invention comprise 1% to 50% by weight of polycarbonate (II), based on the weight of the preparation.

The pigment preparations may comprise further customary auxiliaries, for example surface-active additives, in particular those based on pigment derivatives (so-called pigment synergists), as additional constituents.

Still further auxiliaries for liquid pigment preparations of the present invention in particular include binders, crosslinkers, retention aids, thickeners, biocides and/or additional dispersants.

When additional auxiliaries are used in the pigment preparations of the present invention, their fraction is generally up to 10% by weight.

Liquid pigment preparations of the present invention are preferably waterborne, i.e., they comprise water or mixtures of water and organic solvents, for example alcohols, in particular solvents having a water-retaining effect, as a liquid phase. The liquid phase typically comprises 50% to 90% by weight of these pigment preparations.

Preferably, the pigment preparations of the present invention are solid preparations.

The level of the polycarbonate (II) dispersant of the present invention in solid pigment preparations can be lower or higher.

Suitable compositions for pigment preparations having a lower level of polycarbonate (II) (also known as “surface-modified pigments”) are generally in the range from 80% to 99% by weight and in particular 90% to 98% by weight of pigment (I) and 1% to 20% by weight and in particular 2% to 10% by weight of polycarbonate (III).

The pigments surface modified with the polycarbonates (II) exhibit all the abovementioned positive performance characteristics, for example dispersion softness, high color strength, high transparency and flocculation resistance, and are very useful for coloration of organic and inorganic materials of any kind.

Liquid application media may be purely aqueous; comprise mixtures of water and organic solvents, for example alcohols; or be based exclusively on organic solvents, such as alcohols, glycol ethers, ketones, for example methyl ethyl ketone, amides, for example N-methylpyrrolidone and dimethylformamide, esters, for example ethyl acetate, butyl acetate and methoxypropyl acetate, aromatic or aliphatic hydrocarbons, for example xylene, mineral oil and mineral spirits. Waterborne application media are preferred.

Examples of materials colorable with the pigment preparations of the present invention include:
coatings, for example architectural coatings, industrial coatings, automotive coatings, radiation curable coatings;
paints, both for building exteriors and building interiors, examples being wood paints, lime washes, distempers, emulsion paints;
printing inks, for example offset printing inks, flexographic printing inks, toluene gravure printing inks, textile printing inks, radiation curable printing inks;
inks, including ink jet inks;
color filters;
building materials, for example silicate render systems, cement, concrete, mortar, gypsum;
bitumen;
cellulosic materials, for example paper, paperboard, cardboard, wood and wood-base, which can each be coated or otherwise finished;
adhesives and sealants;
film-forming polymeric protective colloids as used for example in the pharmaceutical industry;
cosmetic articles;
detergents;
plastics,
not only modified natural materials, such as thermosets, for example casein plastics; thermoplastics, for example cellulose nitrate, cellulose acetate, cellulose mixed esters and cellulose ethers,
but also synthetic plastics, such as:
polycondensates: thermosets, for example phenolic resin, urea resin, thiourea resin, melamine resin, unsaturated polyester resin, allylic resin, silicone, polyimide and polybenzimidazole; thermoplastics, for example polyamide, polycarbonate, polyester, polyphenylene oxide, polysulfone and polyvinyl acetal;
addition polymers: thermoplastics, for example polyolefins, such as polyethylene, polypropylene, poly-1-butene and poly-4-methyl-1-pentene, ionomers, polyvinyl chloride, polyvinylidene chloride, polymethyl methacrylate, polyacrylonitrile, polystyrene, polyacetal, fluoropolymers, polyvinyl alcohol, polyvinyl acetate and poly-p-xylylene and also copolymers, such as ethylene-vinyl acetate copolymers, styrene-acrylonitrile copolymers, acrylonitrile-butadiene-styrene copolymers, polyethylene glycol terephthalate and polybutylene glycol terephthalate;
polyadducts: thermosets, for example epoxy resin and crosslinked polyurethanes;
thermoplastics, for example linear polyurethanes and chlorinated polyethers.

Solid pigment preparations of the present invention that have a higher level of dispersing polycarbonate (II) comprise typically 50% to 95% by weight and preferably 70% to 85% by weight of pigment (I) and 5% to 50% by weight and preferably 15% to 30% by weight of polycarbonate (II).

Pigment preparations of the present invention which are in this composition range, as well as the advantageous performance characteristics specified above for the surface modified pigments, feature a particularly pronounced compatibility both with aqueous and nonaqueous liquid application media and also in particular stir-in characteristics, i.e., they can be dispersed in their application media with a very low energy input.

For liquid application media this can be accomplished by simply stirring or shaking, while for plastics it can be accomplished for example by conjoint extrusion (preferably using a single or twin extruder), rolling, kneading or grinding, in which case the plastics can be present as plastically deformable masses or melts and be processed into shaped articles made of plastic, films and fibers.

The polycarbonates of the present invention are useful for dispersing organic and inorganic pigments. Accordingly, the pigment preparations of the present invention may comprise organic or inorganic pigments as component (I).

It will be appreciated that, as with dispersant component (II), the pigment component may also comprise pigment mixtures, i.e., mixtures of various organic or various inorganic pigments or mixtures of (a plurality of) organic and (a plurality of) inorganic pigments.

The pigments are present in the pigment preparations in finely divided form and accordingly their average particle size is typically in the range from 0.02 to 5 μm.

Organic pigments typically comprise organic chromatic and black pigments. Inorganic pigments can likewise be color pigments (chromatic, black and white pigments) and also luster pigments and the inorganic pigments which are typically used as fillers.

Examples of useful organic color pigments include:

Monoazo Pigments: C.I. Pigment Brown 25;
C.I. Pigment Orange 5, 13, 36, 38, 64 and 67;
C.I. Pigment Red 1, 2, 3, 4, 5, 8, 9, 12, 17, 22, 23, 31, 48:1, 48:2, 48:3, 48:4, 49, 49:1, 51:1, 52:1, 52:2, 53, 53:1, 53:3, 57:1, 58:2, 58:4, 63, 112, 146, 148, 170, 175, 184, 185, 187, 191:1, 208, 210, 245, 247 and 251;
C.I. Pigment Yellow 1, 3, 62, 65, 73, 74, 97, 120, 151, 154, 168, 181, 183 and 191;
C.I. Pigment Violet 32;

Disazo Pigments: C.I. Pigment Orange 16, 34, 44 and 72;
C.I. Pigment Yellow 12, 13, 14, 16, 17, 81, 83, 106, 113,126,127,155,174, 176,180 and 188;

Disazo Condensation Pigments: C.I. Pigment Yellow 93, 95 and 128;
C.I. Pigment Red 144,166, 214, 220, 221, 242 and 262;
C.I. Pigment Brown 23 and 41;

Anthanthrone Pigments: C.I. Pigment Red 168;

Anthraquinone Pigments: C.I. Pigment Yellow 147, 177 and 199;
C.I. Pigment Violet 31;

Anthrapyrimidine Pigments: C.I. Pigment Yellow 108;

Quinacridone Pigments: C.I. Pigment Orange 48 and 49;
C.I. Pigment Red 122, 202, 206 and 209;
C.I. Pigment Violet 19;

Quinophthalone Pigments: C.I. Pigment Yellow 138;

Diketopyrrolopyrrole Pigments: C.I. Pigment Orange 71, 73 and 81;
C.I. Pigment Red 254, 255, 264, 270 and 272;

Dioxazine Pigments: C.I. Pigment Violet 23 and 37;
C.I. Pigment Blue 80;

Flavanthrone Pigments: C.I. Pigment Yellow 24;

Indanthrone Pigments: C.I. Pigment Blue 60 and 64;

Isoindoline Pigments: C.I. Pigment Orange 61 and 69;
C.I. Pigment Red 260;
C.I. Pigment Yellow 139 and 185;

Isoindolinone Pigments: C.I. Pigment Yellow 109, 110 and 173;

Isoviolanthrone Pigments: C.I. Pigment Violet 31;

Metal Complex Pigments: C.I. Pigment Red 257;
C.I. Pigment Yellow 117, 129, 150, 153 and 177;
C.I. Pigment Green 8;

Perinone Pigments: C.I. Pigment Orange 43;
C.I. Pigment Red 194;

Perylene Pigments: C.I. Pigment Black 31 and 32;
C.I. Pigment Red 123, 149, 178, 179, 190 and 224;
C.I. Pigment Violet 29;

Phthalocyanine Pigments: C.I. Pigment Blue 15, 15:1, 15:2, 15:3, 15:4, 15:6 and 16;
C.I. Pigment Green 7 and 36;

Pyranthrone Pigments: C.I. Pigment Orange 51;
C.I. Pigment Red 216;

Pyrazoloquinazolone Pigments:C.I. Pigment Orange 67;
C.I. Pigment Red 251;

Thioindigo Pigments: C.I. Pigment Red 88 and 181;
C.I. Pigment Violet 38;

Triarylcarbonium Pigments: C.I. Pigment Blue 1, 61 and 62;
C.I. Pigment Green 1;
C.I. Pigment Red 81, 81:1 and 169;
C.I. Pigment Violet 1, 2, 3 and 27;

C.I. Pigment Black 1 (aniline black);

C.I. Pigment Yellow 101 (aldazine yellow);

C.I. Pigment Brown 22.

Examples of useful inorganic color pigments are:

White Pigments: titanium dioxide (C.I. Pigment White 6), zinc white, pigment grade zinc oxide; zinc sulfide, lithopone;

Black Pigments: iron oxide black (C.I. Pigment Black 11), iron manganese black, spinel black (C.I. Pigment Black 27); carbon black (C.I. Pigment Black 7);

Chromatic Pigments: chromium oxide, chromium oxide hydrate green; chrome green (C.I. Pigment Green 48); cobalt green (C.I. Pigment Green 50); ultramarine green;
cobalt blue (C.I. Pigment Blue 28 and 36; C.I. Pigment Blue 72);
ultramarine blue; manganese blue;
ultramarine violet; cobalt violet and manganese violet;
red iron oxide (C.I. Pigment Red 101); cadmium sulfoselenide (C.I. Pigment Red 108); cerium sulfide (C.I. Pigment Red 265); molybdate red (C.I. Pigment Red 104); ultramarine red;
brown iron oxide (C.I. Pigment Brown 6 and 7), mixed brown, spinel phases and corundum phases (C.I. Pigment Brown 29, 31, 33, 34, 35, 37, 39 and 40), chromium titanium yellow (C.I. Pigment Brown 24), chrome orange;
cerium sulfide (C.I. Pigment Orange 75);
yellow iron oxide (C.I. Pigment Yellow 42); nickel titanium yellow (C.I. Pigment Yellow 53; C.I. Pigment Yellow 157, 158, 159, 160, 161, 162, 163, 164 and 189); chromium titanium yellow; spinel phases (C.I. Pigment Yellow 119); cadmium sulfide and cadmium zinc sulfide (C.I. Pigment Yellow 37 and 35); chrome yellow (C.I. Pigment Yellow 34); bismuth vanadate (C.I. Pigment Yellow 184).

Examples of inorganic pigments typically used as fillers are transparent silica, quartz powder, alumina, aluminum hydroxide, natural mica, natural and precipitated chalk and barium sulfate.

Luster pigments are in particular platelet-shaped pigments having a monophasic or polyphasic construction whose color play is marked by the interplay of interference, reflection and absorption phenomena. Examples are aluminum platelets and aluminum, iron oxide and mica platelets bearing one or more coats, especially of metal oxides.

Examples of preferred pigments (I) are phthalocyanine pigments, indanthrone pigments and perylene pigments.

The solid pigment preparations of the present invention are advantageously obtainable by the production process which is likewise in accordance with the present invention, by said pigment (I) and said dispersant (II) being conjointly subjected to a comminution in the presence of a liquid medium or in the dry state and if appropriate the liquid medium being subsequently removed.

The comminuting operation preferably comprises grinding in a liquid medium or in the dry state.

Dry grinding can be carried out in ball mills, swing mills, planetary mills or attritors for example. Examples of suitable grinding media are steel balls, silicon/aluminum/zirconium oxide (SAZ) beads, glass beads and agate balls, which typically have a diameter in the range from 0.1 to 10 cm and preferably in the range from 2 to 5 cm.

The preferred version of the process comprises wet grinding, in particular in an aqueous suspension comprising at least a portion of dispersant (II).

Stirred ball mills are a particularly useful grinding assembly for this purpose. Preferred grinding media are SAZ beads whose diameter is 0.4 to 3 mm in particular.

The liquid medium used is preferably water, but it is also possible to use mixtures of water with, in particular, water-soluble or water-miscible organic solvents, examples being alcohols.

Pigment (I) can be employed in the process of the present invention as a dry powder or in the form of a press cake.

The employed pigment (I) preferably comprises a finished product, i.e., the primary particle size of the pigment has already been set to the desired value for the planned application. However, unfinished pigments can also be used. In the case of inorganic pigments, examples being oxide and bismuth vanadate pigments, the primary particle size is typically set in the course of the synthesis of the pigment, so that the pigment suspensions generated can be employed directly in the process of the present invention.

Depending on the method of drying chosen—spray granulation and fluidized bed drying, spray drying, drying in a paddle dryer, evaporation and subsequent comminution—the secondary particle size of the pigment preparations of the present invention can also be controlled in a specific manner.

Spray and fluidized bed granulation may produce coarsely divided granules having average particle sizes of 50 to 5000 μm and in particular 100 to 1000 μm. Spray drying typically produces granules having average particle sizes in the range from 50 to 500 μm. Finely divided preparations are obtainable by drying in a paddle dryer and by evaporation with subsequent deagglomerative grinding. Preferably, however, the pigment preparations of the present invention are in granule form.

Spray granulation is preferably carried out in a spray tower using a one material nozzle. Here, the suspension is spray dispensed in the form of relatively large drops, and the water evaporates. The dispersants (II) are either already liquid or melt at the drying temperatures and so lead to the formation of a substantially spherical granule having a particularly smooth surface (BET values generally ≦15 m²/g, in particular ≦10 m²/g).

The gas inlet temperature in the spray tower is generally in the range from 150 to 300° C. and preferably in the range from 160 to 200° C. The gas outlet temperature is generally in the range from 70 to 150° C. and preferably in the range from 70 to 130° C.

The residual moisture content of the granular pigment obtained is preferably <2% by weight.

### EXAMPLES

### A. Production of Inventive Pigment Preparations

### A.1. Production of Polycarbonates Used as a Dispersant

The multifunctional alcohol A, diethyl carbonate and catalyst K (250 ppm, based on the amount of alcohol) were placed in the molar ratio reported in Table 1 in a three neck flask equipped with stirrer, reflux condenser and internal thermometer as an initial charge. The mixture was then heated to 120° C., heated to 140° C. in the case of the run marked * and stirred at that temperature for 2 h. As the reaction progressed, the temperature of the reaction mixture decreased as a consequence of the ensuing evaporative cooling of the liberated ethanol. After the reflux condenser had been replaced with a descending condenser and one equivalent of phosphoric acid had been added per equivalent of catalyst K, the liberated ethanol was distilled off and the temperature of the reaction mixture was gradually raised to 160° C. Conversion was determined by weighing the alcohol distilled off and is reported in Table 1 in mol %, based on the theoretically possible full conversion.

The average molecular weights MW (M_{w} and Mₙ) of the polycarbonates obtained were subsequently determined by gel permeation chromatography using dimethylacetamide as mobile phase and polymethyl methacrylate (PMMA) as the standard.

The viscosity [mPas] of the polycarbonates obtained was measured at 23° C. in accordance with German standard specification DIN 53019 Part 1. Their OH number [mg KOH/g] was determined in accordance with DIN 53240 Part 2.

Further details concerning these experiments and their results are summarized in Table 1. The abbreviations used have the following meanings:
TMP: trimethylolpropane
DEC: diethyl carbonate
PO: propylene oxide
EO: ethylene oxide

TABLE 1

| | | Molar ratio | Catalyst | Conversion | MW [g/mol] | Viscosity | OH number |
|---|---|---|---|---|---|---|---|
| Polycarbonate | Alcohol A | A:DEC | K | [mol %] | M_{w} Mₙ | [mPas] | [mg KOH/g] |
| P1 | TMP × 1.2 PO/ | 1:1 | K₂CO₃ | 70 | 2100 | 7220 | 461 |
| | mol TMP | | | | 1450 | | |
| P2* | TMP × 5.4 PO/ | 1:1 | KOH | 70 | 7800 | 1260 | 227 |
| | mol TMP | | | | 2500 | | |
| P3 | TMP × 12 EO/ | 1:1 | K₂CO₃ | 90 | 5500 | 990 | 164 |
| | mol TMP | | | | 2700 | | |

### A.2. Production of Pigment Preparations

Pigment preparations were produced in 2 steps. First, a suspension of x g of pigment (I) and y g of hyperbranched polycarbonate (II) was suspended in 200 g of water (Examples 1 and 2) or 88 g of water (Example 3), adjusted to pH 8 with dimethylethanolamine (Examples 1 and 2) or ammonia (Example 3) and ground in a stirred ball mill using SAZ beads having a diameter of 1.0-1.6 mm (Examples 1 and 2) or 0.5-0.75 mm (Example 3) to a d₅₀ value of <1 μm. The dispersion obtained after the SAZ beads have been removed was then spray dried in a spray tower with one material nozzle (gas inlet temperature 160-170° C., gas outlet temperature 70-80° C.) by granulation.

The composition of the pigment preparations produced is recited in Table 2.

TABLE 2

| | |
|---|---|
| Pigment | Polycarbonate |

| Example | x g | (I) | y g | (II) |
|---|---|---|---|---|
| 1 | 150 | C.I. Pigment Red 179 | 30 | P1 |
| 2 | 150 | C.I. Pigment Red 179 | 7.5 | P2 |
| 3 | 45 | C.I. Pigment Blue 15:3 | 11.3 | P3 |

### B. Testing of Pigment Preparations Obtained

### B.1. Use in an Aqueous Coating System

The first step was to produce aqueous tinting pastes each comprising 15% by weight of the pigment preparation of Examples 1 and 2 respectively. To this end, a mixture of 100 g of the aqueous polyurethane resin dispersion described in Example 1.3 of WO-A-92/15405, 32.4 g of the pigment preparation of Example 1 or 28.4 g of the pigment preparation of Example 2 and the corresponding amount of water was adjusted to pH 8 with dimethylethanolamine and ground for 4 h in a stirred ball mill containing SAZ beads 1.0-1.6 mm in diameter.

The coating was then produced by adding in each case 34 g of the aqueous tinting pastes obtained to 225 g of a polyurethane based blending varnish (described in Example 3 of WO-A-92/15405). Following the addition of 7.5 g of water, a pH of 8 was established using aminoethanol. The suspension obtained was then stirred at 1000 rpm for 15 minutes using a propeller stirrer.

For comparison V, an aqueous tinting paste and an aqueous coating based on the finished but not surface-modified pigment used in Examples 1 and 2 (use of 27 g of C.I. Pigment Red 179) were produced in a similar manner.

The viscosity was checked by measuring the flow time of the aqueous tinting pastes using a flow sheet (level 5).

The flow sheet has an indentation. The midpoint of this indentation corresponds to level 1. Marks were made at 40 mm intervals along the edge of the sheet to correspond to levels 2 to 5.

Then, 3 g samples of the tinting paste obtained were weighed into the indentation in the sheet lying in a horizontal position. After five minutes of horizontal storage, the sheet was hung up vertically, so that the tinting paste was able to flow downwardly.

Flowability was evaluated by measuring the flow time to get from level 2 to level 5. The shorter the flow time, the lower the viscosity of the tinting paste.

Color strength was determined by white reduction. To this end, 1.6 g of each coating obtained were mixed with 1.0 g of a white paste pigmented with titanium dioxide (Kronos 2310) to 40% by weight (white reduction about ⅓ standard depth of shade), applied to a panel as a 150 μm thick layer, flashed off and baked at 130° C. for 30 min.

The coloration with the comparative pigment V was assigned the FAE coloring equivalent value of 100 (standard). FAE coloring equivalent values <100 denote a higher color strength than standard, while FAE coloring equivalent values >100 denote a lower color strength.

Transparency was determined by drawing down the above-described coating in a layer thickness of 200 μm on a piece of black and white cardboard and, after drying, the scattering Delta E (ddE) over black was determined by comparing with the comparative sample prepared using the V pigment. Negative values denote a higher transparency.

The results obtained are summarized in Table 3.

TABLE 3

| Pigment preparation | Flow time [s] | FAE | Transparency (ddE) |
|---|---|---|---|
| 1 | 25 | 94 | −2.2 |
| 2 | 41 | 91 | −1.5 |
| V | 88 | 100 | — |

### B.2. Use in a Solventborne Baking Finish

The color strength of the pigment preparation of Example 3 was determined by white reduction of an alkyd-melamine baking finish pigmented with this preparation.

A mixture of 0.2 g of the pigment preparation (corresponding to 0.16 g of pigment), 10 g of Kronos 2310 titanium dioxide and 10 g of alkyd-melamine baking finish (solids content about 55% by weight) was shaken in a Skandex shaker with 15 g of glass beads 2 mm in diameter for 30 min, then applied to cardboard using a 100 μm wire-wound doctor and, after flashing off for 10 minutes, baked at 120° C. for 30 min.

The comparison with a coating pigmented with 0.16 g of the finished C.I. Pigment Blue 15:3 used in Example 3 and comprising no polycarbonate revealed a distinctly higher color strength for the inventive pigment preparation.

1: A high functionality hyperbranched polycarbonates obtainable by
a) preparing one or more different condensation products (K) either by
a1) reacting at least one organic carbonate (A) of the general formula RO[(CO)O]ₙR with at least one aliphatic, aliphatic/aromatic or aromatic alcohol (B) having at least 3 OH groups by elimination of alcohols ROH, where each R is independently a straight chain or branched aliphatic, aromatic-aliphatic or aromatic hydrocarbyl radical having 1 to 20 carbon atoms and the R radicals may also be bonded to each other to form a ring comprising the grouping —O[(CO)O]ₙ—, where n is an integer from 1 to 5, or
a2) reacting phosgene, diphosgene or triphosgene with the aliphatic, aliphatic/aromatic or aromatic alcohol (B) to liberate hydrogen chloride,
the quantitative ratio of the alcohols (B) to the carbonates (A) or to the phosgenes in the reaction mixture being so chosen that the condensation products (K) comprise on average either one carbonate or carbamoyl chloride group and more than one OH group or one OH group and more than one carbonate or carbamoyl chloride group,
and
b) intermolecularly reacting the condensation products (K) from step a), as a dispersant for a pigment.

2: A pigment preparation comprising
(I) at least one pigment
and
(II) at least one high functionality hyperbranched polycarbonate according to claim 1 as a dispersant.

3: The pigment preparation according to claim 2 that comprises 1% to 50% by weight of component (II), based on the weight of the preparation.

4: The pigment preparation according to claim 2 that comprises 80% to 99% by weight of component (I) and 1% to 20% by weight of component (II).

5: The pigment preparation according to claim 2 that comprises 50% to 95% by weight of component (I) and 5% to 50% by weight of component (II).

6: A process for producing a pigment preparation according to claim 4, which comprises said pigment (I) and said dispersant (II) being conjointly subjected to a comminution in the presence of a liquid medium or in the dry state and optionally the liquid medium being subsequently removed.

7: The process according to claim 6 wherein said pigment (I) is initially subjected to a wet comminution in an aqueous suspension comprising at least a portion of said dispersant (II) and then said suspension optionally being dried, after addition of the remainder of dispersant (II).

8: The pigment preparation according to claim 2 for coloration of a liquid application medium.

9: The pigment preparation according to claim 8 wherein the liquid application medium is a coating, an ink, a printing ink or a finish system where the liquid phase comprises water, an organic solvent or a mixture of water and an organic solvent.

10: The pigment preparation according to claim 2 for coloration of a plastic.
